(19) United States
(12) Patent Application Publication
(10) Pub. No.: US 2016/0273248 A1
(43) Pub. Date: Sep. 22, 2016

(54) MOTOR VEHICLE DOOR CLOSURE

(71) Applicant: KIEKERT AG, Heiligenahus (DE)

(72) Inventor: Stephan Mittelbach, Velbert (DE)

(73) Assignee: KIEKERT AG, Heiligenahus (DE)

(21) Appl. No.: 15/033,763

(22) PCT Filed: Oct. 1, 2014
(86) PCT No.: PCT/DE2014/100347

§ 371 Date: May 18, 2016

(30) Foreign Application Priority Data
Nov. 2, 2013 (DE) 10 2013 018 461.4

(51) Int. Cl. E05C 3/14; E05B 85/26; E05B 85/10

(52) U.S. Cl. CPC E05C 3/14; E05B 85/10; E05B 85/26

(57) ABSTRACT

The invention relates to a motor vehicle door closure, comprising a locking mechanism supported on a lock plate, which locking mechanism comprises a rotary latch supported on an axis of rotation and at least one pawl for locking the rotary latch, which pawl is also supported on an axis of rotation, the lock plate being fastened to a door or flap of the motor vehicle through openings arranged in the lock plate, characterized in that the lock plate (10) has at least three openings (A, B, C) for fastening, two openings (B, C) being arranged in the region above the axis of rotation (12) of the pawl (11) and one opening (A) being arranged in the region of the axis of rotation (14) of the rotary latch (13), and the openings (A, B, C) enclosing between themselves an acute triangle having an acute angle (Ω) of less than 30° at the fastening opening (A) at the axis of rotation (14) of the rotary latch (13). The lock according to the invention has high stability, in particular high tearing resistance in the event of a crash.

The invention relates to a motor vehicle door latch with a locking mechanism located on a latch plate, which encompasses a catch mounted on a rotational axis and at least one pawl mounted on a rotational axis for the latching of the catch, whereby the latch plate is affixed via openings arranged therein on a door of the motor vehicle.

Within the scope of the invention, a motor vehicle door is understood to mean both doors pivotable via hinges and also so-called sliding doors which can be slid via rails. However, in addition to doors on motor vehicles, the invention also encompasses the customary tailgates, trunk covers and motor hoods.

A motor vehicle door latch, more simply known as a latch for a motor vehicle, encompasses a locking mechanism with a catch pivotably mounted on a rotational axis for the incorporation of a latch holder arranged on the motor vehicle chassis body, which is frequently also known as a locking bolt or a locking clip. Furthermore, the locking mechanism demonstrates at least one pawl pivotably mounted on a rotational axis, via which the catch is latched for holding the retracted latch holder.

In order to retract the latch holder into the catch of a motor vehicle door latch, the catch has a latch holder—intake area formed by means of a load arm and a catching arm. The latch holder goes into the intake area when the relevant door of the motor vehicle is closed. Thus, after the impact of the latch holder onto the catching arm from the open position to the closed position the catch is pivoted where it is latched via the pawl. This position is known as the main latching position. In this position the force is transmitted from the door to the chassis by means of force transmission from the catch to the locking bolt, namely via the load arm of the catch.

In the event of an accident, or a vehicle collision, hereinafter also referred to as a crash, very great forces, in particular acceleration forces, occur, usually suddenly, which can be a multiple of the final acceleration. Thus, a relevant latch including the locking mechanism and the pertaining lever systems are exposed to considerable mass forces which can lead to unwanted opening of the locking mechanism and consequently an opening of the locking mechanism.

In the past, comprehensive steps were already taken which prevent latch activation or locking mechanism opening in the occurrence of abnormal acceleration forces, i.e. in the event of a crash.

Thus, it is known from the publication EP 01 518 983 A2 that in order to prevent unplanned opening of a latch in the event of a crash it is necessary to provide a locking lever which blocks latch activation in the case of excessive motor vehicle accelerations.

In the event of a crash, the excessively strong acceleration forces during impact can lead to a rebound which is also known as bouncing in specialist circles. Due to a delayed and repeated rebound, especially associated with changes in acceleration forces and directions, in the case of very high acceleration forces the locking mechanism by means of which unplanned opening should actually be prevented in the event of a crash can also fail.

In this context, increased significance is attributed to mounting of the latch to the motor vehicle chassis body, in particular mounting of the latch together with the mounting of the locking mechanism consisting of a catch and a pawl.

Motor vehicle door latches are generally screwed via the metal latch plate on which the locking mechanism is mounted via mounting openings with screw recesses with the respective door. Generally, latches are affixed to a door end face, depending on the stop side of the door.

From the publication DE 103 08 369 B4 it is known to affix the latch plate mounted on the locking mechanism via openings arranged, where possible, close to the latch plate edge, whereby here in addition to a mounting on the door end side, mounting also takes place on the lengthwise door side facing the vehicle interior in driving operation.

From the publication DE 38 09 317 A1 it is known that in order to attain beneficial force relationships in the mounting of a latch, the mounting openings, four here, and the rotational axes of the locking mechanism must be aligned. The forces occurring are assumed by the rotational axes of the catch and pawl and delivered to the bearing parts of the motor vehicle door via the mounting openings via screws or bolts.

A latch can also be affixed to a relevant end wall of a motor vehicle door via three mounting openings situated as close as possible to the latch plate edge.

In the past, the latch mounting and the actual protection of the mounting openings in the relevant door or flap were of paramount importance in the constructional ascertainment of the position of the mounting openings.

The invention is now based on the task of optimizing the protection of the rotational axes for mounting of the locking mechanism components pawl and rotational axis in addition to the position of the mounting openings and thus have an overall impact on stability and thus also on the crash behavior of the latch.

In order to solve this task, a motor vehicle door latch is provided with a locking mechanism mounted on a latch plate which encompasses a catch mounted on a rotational axis and at least one pawl also mounted on a rotational axis for latching of the catch. The latch plate is affixed to a door or flap of the motor vehicle via openings arranged therein. The latch plate demonstrates at least three openings for mounting, whereby two openings are arranged in the area above the rotational axis of the pawl and an opening is arranged in the area of the rotational axis of the catch, and whereby the openings include an acute-angled triangle with an acute angle of less than 30° on the mounting opening on the rotational axis of the catch.

With such a ratio of the arrangement of the mounting openings to one another defined by means of the triangular design in the circular arc with specific angles, an optimum stability of the latch is initially attained in the installation state, whereby simultaneously the mountings of the locking mechanism components catch and pawl are protected via their rotational axes in the affixed state of the motor vehicle latch to a relevant door or flap in an advantageous manner in the event of a crash.

In a preferred execution form of the invention, it is envisaged that the acute angle on the mounting opening of the rotational axis of the catch is 23°-29°, preferably 26°.

In the case of such a specified angle design, optimum stability is attained for the motor vehicle door latch with the mounting in accordance with the invention. Even exactly three mounting openings can be sufficient for this purpose.

In a further preferred execution form, it is envisaged that the at least three mounting openings are arranged approximately on a circular orbit with a radius of 30 mm-36 mm, preferably 33 mm.

With such a further specification of the arrangement of the position of the mounting openings the stability is further optimized for three mounting openings.

In a further preferred design of the invention it is envisaged that two mounting openings are located on the side of the latch holder intake area of the catch.

Due to such an arrangement ratio of the mounting openings, great stability of the latch is attained during entry of the latch holder, or more precisely is attained upon impact of the latch holder on the catching arm of the catch. With this arrangement, improvements are also attained for the latch acoustics during closure of a door or flap equipped therewith, in conjunction with the further constructional mounting details.

In an especially preferred execution form of the invention, the ratio of the distance of the central points of the mounting openings situated above the rotational axis of the pawl to the distance of the central points of the mounting openings situated on the side of the latch holder intake area is approximately 0.4.

Due to the special ratio of the position of the screwing point in the area of the rotational axis of the pawl and the rotational axis of the catch according to the invention the additional protection of the mountings of the locking mechanism components catch and pawl referred to above is further optimized.

In a further special execution form of the motor vehicle door latch according to the invention, it is envisaged that a straight line between the central points of catch and pawl on the rotational axis crosses a straight line between the mounting opening on the catch and the mounting opening situated at the front of the pawl in a clockwise direction with a vertical angle of less than 35°.

As a result, the ratio of the position of the screwing points to the position of the rotational axes of the locking mechanism components catch and pawl is further optimized in the direction of greater latch stability.

In a very special execution of the motor vehicle door latch according to the invention, the vertical angle is approximately 30°.

With this design of the motor vehicle door latch an optimum is attained with regard to the desired latch stability in the event of a crash.

In a further special execution form of the invention, the respective distances between the vertical lines through the central points of the mounting openings and the vertical lines through the central points of the rotational axes of the pawl and the catch are a maximum of 18 mm.

Due to this compared to the state of the art, in which the edge areas of the latch plate tend to be viewed as preferable to the arrangement of the mounting openings, with the specified arrangement of the mounting openings close to the rotational axes—mounting sites of the locking mechanism components catch and pawl, an especially positive effect is attained on the tensile strength of the motor vehicle door latch in the event of a crash. Forces triggered via the latch holder by the motor vehicle chassis into the locking mechanism in the case of a crash are absorbed in the shortest possible time.

A further special execution form of the invention envisages that the distances between the horizontal lines through the central points of the mounting openings in the area of the pawl and the horizontal lines through the central point of the rotational axis of the pawl are a maximum of 14 mm.

As a result, tensile strength is further optimized in the area of the pawl mounting in the event of a crash, namely via the horizontal plane of the latch plate.

A further special execution form of the invention envisages that the distance between the horizontal line through the central point of the mounting opening on the catch and the horizontal line through the central point of the rotational axis of the catch is a maximum of 12 mm.

As a result, tensile strength is further optimized in the area of the catch mounting in the event of a crash, here via the horizontal plane of the latch plate in the area of the catch mounting.

It is finally mentioned that the mounting openings are executed as drilled borings with a thread recess for screwing the motor vehicle door latch to a door or a flap of a motor vehicle. With such screwing, an optimum connection is attained to the relevant door or flap of the motor vehicle, both from a stability-related and aesthetic perspective.

Hereinafter the invention is explained in further detail by means of sketches on the basis of an execution example. Both figures show:

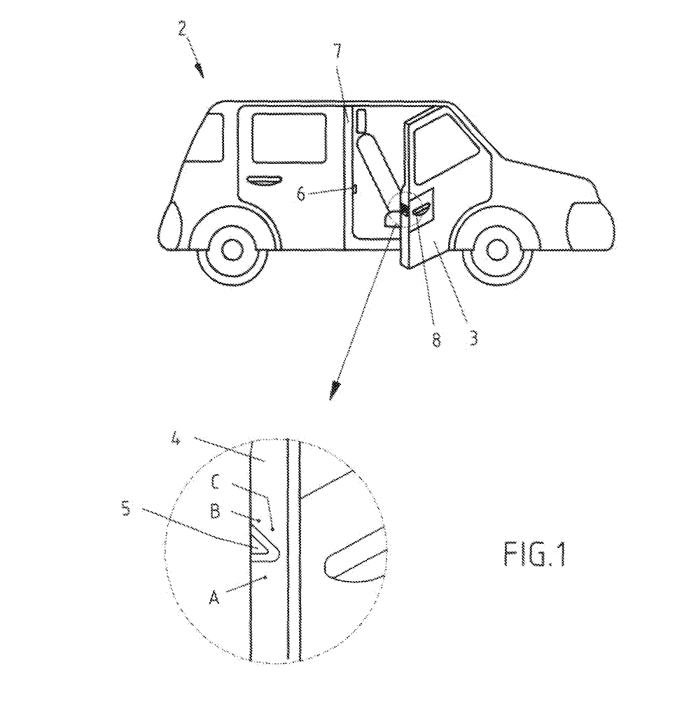

FIG. 1: The screwing points on the end side of a motor vehicle door

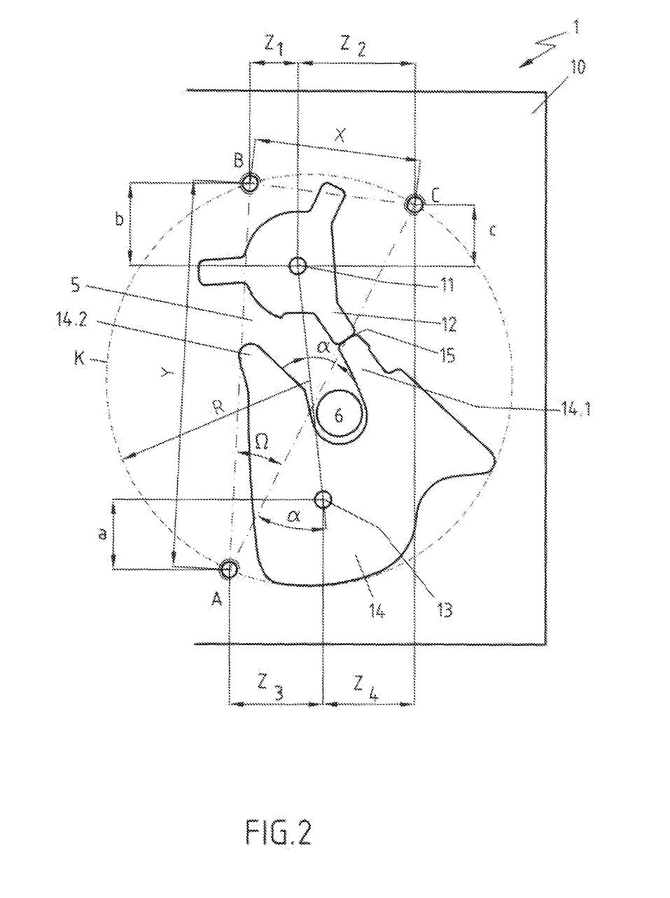

FIG. 2: A top view of the motor vehicle door latch

FIG. 1 shows a motor vehicle 2 with a front lateral door 3 pivoted in the open position affixed by hinges. On the end side 4 of the lateral door 3 as is customary for motor vehicles 2 the motor vehicle door latch 1 predominantly arranged within the lateral door 3 is only visible hazily via its mounting points A B C and the latch holder—intake area 5. The latch holder 6 itself is located on the chassis pillar 7. The latch is screwed via thread recesses inserted in the latch plate 10 to the mounting openings A B C on the end side 4 with the lateral door 3 using screws not shown here. However, within the scope of the invention, it is also a case of mounting via bolts for A B C to be riveted, for example. For the sake of completeness, it is mentioned that the latch 1 is activated externally via a door handle 8.

FIG. 2 shows the motor vehicle door latch 1 in the view without a latch cover from the door interior. On the latch plate 10 arranged in a non-illustrated latch housing only depicted in a diagram the locking mechanism 12, 14 consisting of a pawl 12 and a catch 14 is visible, whereby the pawl 12 is pivotably mounted via a rotational axis 11 and the catch 14 is pivotably mounted via a rotational axis 13. The latch holder 6 is fully inserted in the latch holder intake area 5 of the catch 13 consisting of a catch catching arm 14.1 and a catch load arm 14.2. The catch 14 is latched with the pawl 12. Consequently, the locking mechanism 12, 14 is in the main latching position 15.

It is explained merely for better comprehension that upon activation of a latch activation lever not shown in FIG. 2, e.g. of the door handle 8 the pawl 12 would move in an anti-clockwise direction from the main latching position 15 in a spring-loaded manner and thus the also spring-loaded catch 14 would also pivot in an anti-clockwise direction in the opening position.

With A, B and C three mounting openings are arranged in the latch plate 10 of the motor vehicle door latch 1. Preferably, the three mounting openings are arranged on a circular orbit K drawn with a radius R, whereby the radius R is 30 mm-36 mm, preferably 33 mm. The mounting openings are drilled borings each equipped with a thread recess of a preferably M12 thread. Screwing generally takes place externally via the door edge side 4.

With such a ratio defined as an acute-angled triangle as marked of the arrangement of the mounting openings A B and C to one another an optimum stability of the latch in the installation state is initially attained, preferably with an acute angle Ω on the mounting opening A close to the rotational axis 13 of the catch 14 of less than 30°, especially between 23° and 29°, particularly 26°. An optimum distance x between the center points of the mounting openings B and C has been proven to be a value of 25 to 29 mm, preferably approximately 27 mm, and the center points of the mounting openings A and B are preferably 62 mm to 66 mm, particularly preferably approximately 64 mm from one another, which results in the preferred length ratio x:y of 0.35 to 0.45, i.e. approximately 0.4.

In order to simultaneously produce optimum protection of the locking mechanism rotational axes 11, 13 and thus increased tensile strength for the latch 1 via the latch mounting A, B and C, locking mechanism rotational axis arrangements 11, 13 have proven preferable, in which the connection of the center points of the rotational axes 12, 14 and the connection of the center points of the mounting openings A and C cross with a vertical angle α of less than 35°, preferably 30°.

An optimum distance of the mounting openings A, B and C to the rotational axes 11, 13 of the locking mechanism 12, 14 have been proven in the invention as especially preferable compared to the state of the art.

Thus, the motor vehicle door latch 1 in accordance with the invention preferably demonstrates a maximum distance z1-z4 between the vertical lines through the center points of the mounting openings A, B and C and the vertical lines through the center points of the rotational axes 11, 13 of pawl 12 and catch 14 of a maximum of only 18 mm. Preferable dimensions for distance z1 have been proven to be approximately 9.5 mm, distance z2 is approximately 17.5 mm (in particular 16.5 mm to 18. 5 mm), distance z3 approximately 18 mm (in particular 17 mm to 19 mm) and distance z4 approximately 15 mm (in particular 14 mm to 16 mm).

For the distances b, c between the horizontal lines through the center points of the mounting openings B, C to the horizontal lines through the rotational axis 12 of the pawl 11 an optimum value of maximum 14 mm has been proven, whereby an especially preferred execution demonstrates values for b of 12 mm and for c of 13.5 mm in accordance with FIG. 2.

Finally, the determination of the distance a between the horizontal lines through the center point of the mounting opening A and the horizontal lines through the rotational axis 13 of the catch 14 remains. Here, optimum values have resulted for distances of a maximum of 12 mm, whereby the specific case in accordance with the Figure demonstrates 11 mm.

### REFERENCE SIGN LIST

1. Motor vehicle door latch

2. Motor vehicle

3. Motor vehicle lateral door

4. Door end side

5. Latch holder intake area

6. Latch holder

7. Chassis pillar

8. Door handle

10. Latch plate

11. Rotational axis pawl

12. Pawl

13. Rotational axis catch

14. Catch

14.1 Catching arm

14.2 Load arm

15. Main latching position

A Mounting opening

B Mounting opening

C Mounting opening

K Circular orbit

R Radius

a Distance

b Distance

c Distance

z1-z4 Distances

x Distance

y Distance

α Angle Ω Angle

1. A motor vehicle door latch with a locking mechanism mounted on a latch plate, which encompasses a catch mounted on a rotational axis and at least one pawl also mounted on a rotational axis for latching of the catch, whereby the latch plate is mounted via openings arranged therein on a door or a flap of the motor vehicle, characterized in that the latch plate demonstrates at least three openings for mounting, whereby two openings are arranged in the area above the rotational axis of the pawl and one opening is arranged in the area of the rotational axis of the catch, and whereby the openings include an acute-angled triangle with an acute angle of less than 30° on the mounting opening on the rotational axis of the catch.

2. The motor vehicle door latch according to claim 1, wherein the angle on the mounting opening on the rotational axis of the catch is 23°-29°, preferably 26°.

3. The motor vehicle door latch according to claim 1, wherein the at least three mounting openings are approximately arranged on a circular orbit created with a radius of 30 mm-36 mm, preferably 33 mm.

4. The motor vehicle door latch according to claim 1, wherein two mounting openings are located on the side of the latch holder intake area of the catch.

5. The motor vehicle door latch according to claim 1, wherein the ratio of the distance of the center points of the mounting openings located above the rotational axis of the pawl to the distance of the center points of the borings located on the latch holder intake area is approximately 0.4.

6. The motor vehicle door latch according to claim 1, wherein a straight line between the rotational axis center points of the pawl and the catch and a straight line between the mounting openings cross with a vertical angle of less than 35°.

7. The motor vehicle door latch according to claim 6, wherein the angle is approximately 30°.

8. The motor vehicle door latch according to claim 1, wherein the distances z1-z4 between the vertical lines through the center points of the mounting openings and the vertical lines through the center points of the rotational axes of the pawl and the catch are a maximum of 18 mm.

9. The motor vehicle door latch according to claim 1, wherein the distances between the horizontal lines through the center points of the mounting openings and through the center point of the horizontal lines through the rotational axis of the pawl is a maximum of 14 mm.

10. The motor vehicle door latch according to claim 1, wherein the distance between the horizontal lines through the center point of the mounting opening and the horizontal lines through the center point of the rotational axis of the catch are a maximum of 12 mm.

11. The motor vehicle door latch according to claim 1, wherein the mounting openings for the screwing of the motor vehicle door latch to a door or flap of a vehicle are executed as drilled borings with a thread recess.
